(19) United States
(12) Patent Application Publication
(10) Pub. No.: US 2023/0377079 A1
(43) Pub. Date: Nov. 23, 2023

(54) System and Method for Providing Taxi Service

(71) Applicants: Hyundai Motor Company, Seoul (KR); Kia Corporation, Seoul (KR)

(72) Inventors: Yunjoong Park, Seoul (KR); Jeongtaek Oh, Yongin-si (KR); Byeonghwi Choi, Suwon-si (KR)

(21) Appl. No.: 17/973,106

(22) Filed: Oct. 25, 2022

(30) Foreign Application Priority Data
May 20, 2022 (KR) 10-2022-0061907

(51) Int. Cl. G06Q 50/26; G06Q 50/30

(52) U.S. Cl. CPC G06Q 50/265; G06Q 50/30

(57) ABSTRACT

An embodiment system for providing a taxi service includes an integrated terminal configured to communicate with an operating server that provides a response to a request received from a user terminal through a network, wherein the integrated terminal is configured to receive a vehicle number information query result in response to a vehicle number information query request from a first operating server, receive a business information identification result in response to a business information identification request from a second operating server, and request the first operating server to register the integrated terminal by using the business information and the vehicle number information comprising a vehicle identification number (VIN) and an automobile registration number.

### CROSS-REFERENCE TO RELATED APPLICATIONS

This application claims the benefit of Korean Patent Application No. 10-2022-0061907, filed on May 20, 2022, which application is hereby incorporated herein by reference.

### TECHNICAL FIELD

The present disclosure relates to a system and a method for providing a taxi service.

### BACKGROUND

In order to provide a taxi service, a procedure is cumbersome and a long time is required by a scheme in which a driver prepares information for a terminal subscription and delivers the information directly to a dealer or sends the information by e-mail. In addition, if an error occurs during the terminal subscription and registration process, the driver and the dealer must respond manually.

In the case of a corporate taxi with multiple drivers who provide the taxi service with a single vehicle, a registration and operation procedure becomes more complicated, which should conduct a separate procedure to record a business of each driver whenever the driver changes.

Therefore, there is a need for a driver who wants to provide a taxi service and develop a system which can easily register business vehicles and terminals and into which multiple drivers can log in.

The above information disclosed in this background section is only for enhancement of understanding of the background of embodiments of the invention, and therefore it may contain information that does not form the prior art that is already known to a person of ordinary skill in the art.

### SUMMARY

Embodiments of the present disclosure provide a system and a method for providing a taxi service, which can conduct a terminal registration procedure directly by querying and identifying a VIN, an automobile registration number, and a business registration number to the operating server.

Embodiments of the present disclosure provide a system and a method for providing a taxi service, which can provide the taxi service by registering a plurality of personal information and selecting registered personal information by drivers of a corporate taxi when a taxi type is the corporate taxi.

Embodiments of the present disclosure provide a system and a method for providing a taxi service, which can change a closed or business mode through a mode selection screen.

An exemplary embodiment of the present disclosure provides a system for providing a taxi service, which includes an integrated terminal which is connected to an operating server providing a response to a request received from a user terminal through a network, and receives a vehicle number information query result in response to the vehicle number information query request from a first operating server, receives a business information identification result in response to the business information identification request from a second operating server, and requests the first operating server to register the integrated terminal by using vehicle number information including a vehicle identification number (VIN) and an automobile registration number, and the business information.

The integrated terminal may receive the VIN from a vehicle.

The integrated terminal may include an information registration unit receiving vehicle type information, the vehicle number information, and the business information, receiving the integrated terminal registration processing result, and requesting and receiving personal information for a driver of the vehicle. The vehicle type information may include information regarding whether the vehicle is a vehicle operated by an individual or a vehicle operated by a corporation, and the personal information may include at least one of a driver code including a taxi driving license number, a cellular phone number, and an employee ID number.

The integrated terminal may include an operation record unit receiving the VIN and the automobile registration number, requesting the query of the vehicle number information to the first operating server, receiving an identification result of the business information, and requesting the first operating server to register the integrated terminal by using the queried vehicle number information and the identified business information.

The integrated terminal may include a meter unit requesting the second operating server to identify the business information by receiving the business information.

The vehicle number information query result may include at least any one of a result of querying whether the automobile registration number is a number registered in the first operating server and a result of querying whether the VIN and the automobile registration number correspond to each other.

The business information identification result may include a result of identifying whether a business registration number is a number registered in the second operating server.

The first operating server may be a server of a public organization such as Korea Traffic Safety Corporation or an ITS (Intelligent Transport Systems)-related organization.

The second operating server may be an app meter business server.

The integrated terminal may include a mode selection unit controlling another screen to be output according to a selected mode. The mode may include a business mode and a closed mode, the mode selection unit may control a taxi business interface screen including a map screen and a business screen to be output in the business mode, and the mode selection unit may control a general vehicle interface screen to be output in the closed mode.

Another exemplary embodiment of the present disclosure provides a method for providing a taxi service, which includes receiving, by an integrated terminal, a vehicle number information query result in response to the vehicle number information query request from a first operating server, receiving, by the integrated terminal, a business information identification result in response to the business information identification request from a second operating server, and requesting, by the integrated terminal, the first operating server to register the integrated terminal by using the vehicle number information including a vehicle identification number (VIN) and an automobile registration number, and the business information.

The method may further include receiving, by the integrated terminal, the VIN from a vehicle.

The method may further include requesting, by the integrated terminal, inputting vehicle type information, the vehicle number information, and the business information and requesting inputting personal information for a driver of the vehicle.

The vehicle type information may include information regarding whether the vehicle is a vehicle operated by an individual or a vehicle operated by a corporation.

The personal information may include at least one of a driver code including a taxi driving license number, a cellular phone number, and an employee ID number.

The receiving, by the integrated terminal, of the vehicle number information query result in response to the vehicle number information query request from the first operating server may include at least any one of receiving, by the integrated terminal, a result of querying whether the automobile registration number is a number registered in the first operating server, and receiving, by the integrated terminal, a result of querying whether the VIN and the automobile registration number correspond to each other.

The receiving, by the integrated terminal, of the business information identification result in response to the business information identification request from the second operating server may include receiving, by the integrated terminal, a result of querying whether a business registration number is a number registered in the second operating server.

The first operating server may be a server of a public organization such as Korea Traffic Safety Corporation or an ITS (Intelligent Transport Systems)-related organization.

The second operating server may be an app meter business server.

The method may further include outputting, by the integrated terminal, another screen according to a selected mode, in which the mode includes a business mode and a closed mode, outputting, by the integrated terminal, a taxi business interface screen including a map screen and a business screen when the business mode is selected, and outputting, by the integrated terminal, a general vehicle interface screen when the closed mode is selected.

According to exemplary embodiments of the present disclosure, a system and a method for providing a taxi service can be provided, which can conveniently and accurately identify availability of each information by a driver who intends to provide the taxi service, and increase convenience of a terminal registration procedure.

A system and a method for providing a taxi service can be provided, which can efficiently perform a taxi business even by using one vehicle, and conveniently provide the taxi service by the driver of the corporate taxi.

A system and a method for providing a taxi service can be provided, which can perform both general driving and taxi service provided by one vehicle to efficiently and conveniently provide the taxi service.

### BRIEF DESCRIPTION OF THE DRAWINGS

FIG. 1 is a block diagram schematically illustrating a configuration of a system for providing a taxi service according to an exemplary embodiment.

FIG. 2 is a flowchart of a vehicle number information query method according to an exemplary embodiment.

FIG. 3 is a flowchart of a method for identifying business information according to an exemplary embodiment.

FIG. 4 is a flowchart of a terminal registration method according to an exemplary embodiment.

FIG. 5 is a view illustrating a mode selection screen according to an exemplary embodiment.

FIG. 6 is a view illustrating a closed mode screen according to an exemplary embodiment.

FIG. 7 is a view illustrating a business mode screen according to an exemplary embodiment.

The following reference identifiers may be used in connection with the accompanying drawings to describe exemplary embodiments of the present disclosure.
1: Taxi service providing system
10: Vehicle
101: ECU (Electronic Control Unit)
103: Communication unit
105: Memory
20: Integrated terminal
201: Application device
2011: Information registration unit
2013: Mode selection unit
2015: Meter unit
2017: Operation record unit
203: Memory
205: MICOM (microcomputer)
207: API (Application Programming Interface)
209: Input/output unit
30: First operating server
40: Second operating server
500: Mode selection screen
501: ‘Business’ mode selection button
503: ‘Closed’ mode selection button
505: Guide message
700: Taxi business interface screen
701: Map screen
703: Business screen

### DETAILED DESCRIPTION OF ILLUSTRATIVE EMBODIMENTS

Hereinafter, exemplary embodiments disclosed in this specification will be described in detail with reference to the accompanying drawings and the same or similar components are denoted by the same or similar reference numerals, and duplicated description thereof will be omitted. Suffixes “module” and/or “unit” for components used in the following description are given or mixed in consideration of easy preparation of the present disclosure only and do not have their own distinguished meanings or roles. Further, in describing an embodiment disclosed in the present disclosure, a detailed description of related known technologies will be omitted if it is determined that the detailed description makes the gist of the embodiment of the present disclosure unclear. Further, it is to be understood that the accompanying drawings are just used for easily understanding the exemplary embodiments disclosed in this specification and a technical spirit disclosed in this specification is not limited by the accompanying drawings and all changes, equivalents, or substitutes included in the spirit and the technical scope of the present disclosure are included.

Terms including an ordinary number, such as first and second, are used for describing various elements, but the elements are not limited by the terms. The terms are used only to discriminate one element from another element.

In the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In a component controlling other components under a specific control condition among components according to an exemplary embodiment, a program implemented by a set of commands materializing a control algorithm required for controlling other components may be installed. The control component may process input information and stored information according to the installed program and generate output information. The control component may include a non-volatile memory storing the program and a memory storing the information.

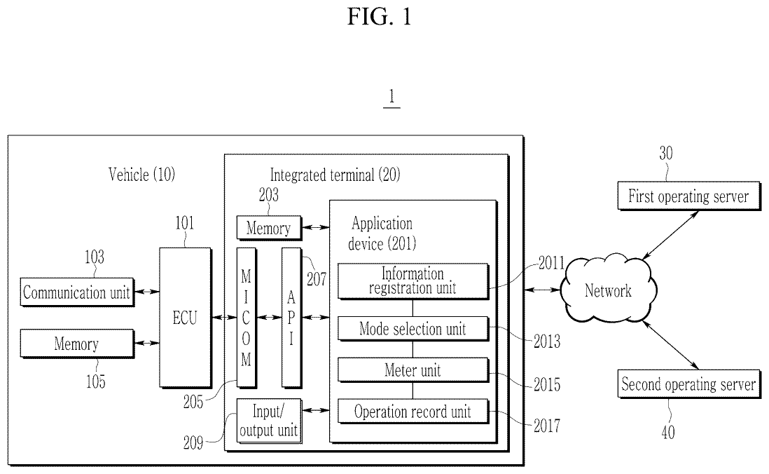

FIG. 1 is a block diagram schematically illustrating a configuration of a system for providing a taxi service according to an exemplary embodiment.

The taxi service providing system 1 may include a vehicle 10, a first operating server 30, and a second operating server 40.

As illustrated in FIG. 1, the vehicle 10, the first operating server 30, and the second operating server 40 may transmit and receive required information through a network. In this case, the vehicle 10 may be a taxi operated by a driver who provides a taxi service.

In embodiments of the present disclosure, the network may be a Personal Area Network (PAN), a Local Area Network (LAN), a Campus Area Network (CAN), a Metropolitan Area Network (MAN), a Wide Area Network (WAN), a Broadband Network (BBN), a wireless LAN (WLAN), a Storage Area Network (SAN), and a Controller Area Network (CAN), and may also be cellular communication such as Long Term Evolution (LTE), LTE Advanced (LTE-A), Code-Division Multiple Access (CDMA), Wideband Code Division Multiplex Access (WCDMA), Universal Mobile Telecommunication System (UMTS), Wireless Broadband (WiBro), Global System for Mobile Communications (GSM), etc., but is not limited thereto.

The vehicle 10 includes an electronic control unit (ECU) 101, a communication unit 103, a memory 105, and an integrated terminal 20.

The vehicle 10 may transmit and receive required information to and from the integrated terminal 20 by a scheme of transmitting information stored in the memory 105 to the integrated terminal 20 through the ECU 101 or receiving information from the integrated terminal 20 through the ECU 101.

The ECU 101 may generate a control command for operating each component of the vehicle 10. For example, the ECU 101 may process information received through the communication unit 103 and transmit the processed information to the integrated terminal 20.

The communication unit 103 may transmit a control command of the ECU 101 or the information stored in the memory 105 to the outside, and transfer the information received from the outside to the ECU 101.

The memory 105 may store information required for each component of the vehicle 10 to operate, information to be transmitted to the integrated terminal 20, etc.

The integrated terminal 20 may include an application device 201, a memory 203, a microcomputer (MICOM) 205, an application programming interface (API) 207, and an input/output unit 209.

The integrated terminal 20 receives VIN information from the ECU 101 and communicates with the first operating server 30 and the second operating server 40 to review the availability of the information and perform registration of the integrated terminal 20.

The application device 201 may include an information registration unit 2011, a mode selection unit 2013, a meter unit 2015, and an operation record unit 2017.

The application device 201 may receive information on the vehicle 10, generate vehicle type information, vehicle number information, business information, terminal registration information, etc., by using the received information, and transmit the generated information. An application of the application device 201 may request transmitting a query or identification request to the communication unit 103 through the API 207, the MICOM 205, and the ECU 101, and the communication unit 103 may transmit the request to the operating server. In the following description, transmitting the information, the request, etc. (hereinafter, collectively referred to as information) to the operating server by a predetermined application may mean an operation of transmitting the information to the ECU 101 through the API 207 and the MICOM 205 by a predetermined application and transmitting information received from a predetermined application by the communication unit 103 by the control of the ECU 101. Further, receiving information from the operating server by a predetermined application may mean an operation in which the information received by the communication unit 103 from the operating server is delivered to the ECU 101, the ECU 101 collects information to be transmitted to the application device among the received information and transmits the collected information to the MICOM 205, the MICOM 205 delivers the received information to a predetermined application through the API 207, and a predetermined application receives the delivered information. However, the present disclosure is not limited thereto, and direct communication between the application device 201 and the communication unit 103 may be possible.

In an exemplary embodiment, each of the information registration unit 2011, the mode selection unit 2013, the meter unit 2015, and the operation record unit 2017 as an application for performing a unique function may process allocated information and display a processing result in the input/output unit 209. Some applications may transmit the processing result to the MICOM 205 so as to transmit the processing result to the first operating server 30 or the second operating server 40. The MICOM 205 may allow the ECU 101 to transmit the processing result to the first operating server 30 or the second operating server 40 or directly transmit the processing result to the first operating server 30 or the second operating server 40 through the communication unit 103.

The information registration unit 2011 may generate a vehicle type, a vehicle number, and business information. Further, the information registration unit 2011 may transmit and receive information to and from the ECU 101, the meter unit 2015, and the operation record unit 2017 in order to register the integrated terminal 20 in the first operating server 30. The information registration unit 2011 may register personal information. The personal information registered in the information registration unit 2011 may be stored in the memory 203.

The mode selection unit 2013 may control the input/output unit 209 to output another screen according to the business mode or the closed mode.

The meter unit 2015 may include an app meter that calculates an operation fee of the vehicle 10 by using GPS information or information collected by a sensor of the vehicle 10. Further, the meter unit 2015 may transmit and receive information to and from the information registration unit 2011, the operation record unit 2017, and the second operating server 40 in order to register the integrated terminal 20 in the first operating server 30. The meter unit 2015 may change the type of app meter used according to input information received by the input/output unit 209.

The operation record unit 2017 may record operation information such as a speed, a location, RPM, etc., of the vehicle 10 by using the GPS information or the information collected by the sensor of the vehicle 10. The operation record unit 2017 may include a digital tacho graph (DTG). Further, the operation record unit 2017 may transmit and receive information to and from the information registration unit 2011, the meter unit 2015, and the first operating server 30 in order to register the integrated terminal 20 in the first operating server 30.

The memory 203 may store information required for each component of the integrated terminal 20 to operate, the information received from the ECU 101, etc.

The MICOM 205 may deliver the information received from the ECU 101 to the application device 201 through the API 207. In this case, the MICOM 205 may control the API 207 to transmit the information received from the ECU 101 to a corresponding application. The ECU 101 may transmit the information stored in the memory 105 of the vehicle 10 to the MICOM 205 through CAN communication, and the MICOM 205 may transmit the collected information to the corresponding application in the application device 201 through the API 207.

The API 207 may perform communication between the ECU 101 and the application device 201. For example, the ECU 101 may transmit the information stored in the memory 105 of the vehicle 10 to the application device 201 through the API 207.

The input/output unit 209 may generate input information for controlling the operation of the integrated terminal 20 and output an audio signal (or a signal related to hearing), a video signal (or a signal related to vision), or an alarm signal (or a signal related to tactics). For example, the input/output unit 209 may be a touch display, etc.

The first operating server 30 and the second operating server 40 may be servers that receive a request for a service from the integrated terminal 20 and provide a response to the received request. For example, the integrated terminal 20 may request a query of vehicle number information to the first operating server 30 and the first operating server 30 may query the vehicle number information in response thereto and transmit a query result to the integrated terminal 20. The first operating server may be a server of a public organization such as the Korea Traffic Safety Corporation or an ITS (Intelligent Transport Systems)-related organization. Here, as a specific example, the first operating server 30 may be the Korea Traffic Safety Corporation server which may transmit and receive information in association with an automobile management information system of the Ministry of Land, Infrastructure, and Transport. Specifically, the first operating server 30 may be a taxi operation information management system (TIMS) server of the Korea Traffic Safety Corporation. As another example, the integrated terminal 20 may request identification of the business information to the second operating server 40 and the second operating server 40 may identify the business information in response thereto and transmit an identification result to the integrated terminal 20. Here the second operating server 40 may be an app meter business server. As such, an example of the first operating server 30 may be a server of a public organization such as the Korea Traffic Safety Corporation or an ITS (Intelligent Transport Systems)-related organization and an example of the second operating server 40 may be the app meter business server, and in the following exemplary embodiment, a feature for the operating server will be accordingly described. However, the present disclosure is not limited thereto, and the first operating server 30 or the second operating server 40 may be different types of servers for providing different services.

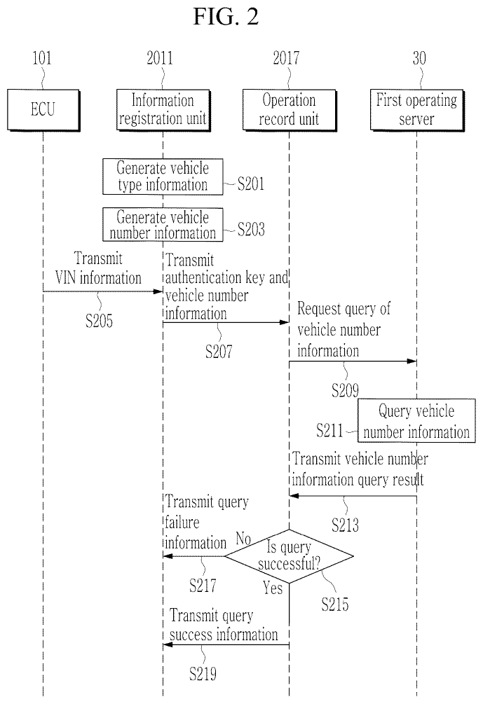

FIG. 2 is a flowchart of a vehicle number information query method according to an exemplary embodiment.

The information registration unit 2011 generates the vehicle type information (S201).

For example, the information registration unit 2011 may control the input/output unit 209 to output a screen for requesting the driver to input the vehicle type. The driver may input the vehicle type thereof through the input/output unit 209. The information registration unit 2011 may generate the vehicle type information by receiving the information input from the input/output unit 209. The vehicle type information may include information regarding whether the corresponding vehicle is a vehicle operated by an individual or a vehicle operated by a corporation.

Further, the information registration unit 2011 generates the vehicle number information (S203).

For example, the information registration unit 2011 may control the input/output unit 209 to output a screen for requesting the driver to input the vehicle number information. The driver may input the vehicle number information through the input/output unit 209. The information registration unit 2011 may generate the vehicle number information by receiving the information input from the input/output unit 209. The vehicle number information may include information on numbers used to identify the vehicle, such as a license number, an automobile registration number, the VIN, etc. The automobile registration number may be a type in which a vehicle type symbol constituted by numbers of three digits or less, a use symbol constituted by one Korean character, and a serial number constituted by four digits are sequentially combined. The vehicle identification number (VIN) as a unique number granted for each vehicle may be stored in the memory 105 of the vehicle 10.

The ECU 101 transmits the VIN information to the information registration unit 2011 (S205).

For example, the ECU 101 may transmit the VIN information stored in the memory 105 to the information registration unit 2011 through the MICOM 205 and the API 207.

The information registration unit 2011 transmits an authentication key and the vehicle number information to the operation record unit 2017 (S207).

For example, the information registration unit 2011 may transmit, to the operation record unit 2017, the vehicle number information including the VIN and the automobile registration number jointly with the authentication key. The authentication key may be used for performing communication with an external server such as the first operating server 30.

The operation record unit 2017 requests query of the vehicle number information to the first operating server 30 (S209).

For example, the operation record unit 2017 may request query of the vehicle number information to the first operating server 30 jointly with the received VIN, automobile registration number, and authentication key.

The first operating server 30 queries the vehicle number information (S211).

The first operating server 30 transmits a vehicle number information query result to the operation record unit 2017 (S213).

For example, the first operating server 30 may query whether the received automobile registration number is a number registered in the first operating server 30, and whether the received VIN and automobile registration number correspond to each other. The first operating server 30 may determine that the vehicle number information query is unsuccessful when the received automobile registration number does not correspond to the number registered in the first operating server 30 or the received VIN and automobile registration number do not correspond to each other. The first operating server 30 may determine that the vehicle number information query is successful when the received automobile registration number is the number registered in the first operating server 30 and the received VIN and automobile registration number correspond to each other. The first operating server 30 may transmit a query result including vehicle number information query success or failure information to the operation record unit 2017.

The operation record unit 2017 determines whether the query is successful (S215).

The operation record unit 2017 transmits the received query failure information to the information registration unit 2011 when the vehicle number information query is unsuccessful (S217).

For example, the query failure information may include a message for indicating the automobile registration number is in an unregistered state or a message for guiding an operating time at which the automobile registration number is capable of being registered when the query is unsuccessful for a reason in which the automobile registration number is in the unregistered state. As another example, the query failure information may include a message indicating that the automobile registration number does not coincide with the registered number or a registered number corresponding to the VIN when the query is unsuccessful because the automobile registration number does not coincide with the registered number corresponding to the VIN. Further, the input/output unit 209 outputs the query failure information to allow the driver to identify the corresponding information.

The operation record unit 2017 transmits the received query success information to the information registration unit 2011 when the vehicle number information query is successful (S219).

For example, the query success information may include a message for informing that the VIN and the automobile registration number are information registered in the first operating server 30 and a message for guiding a business information identification procedure. Further, the input/output unit 209 outputs the query failure information to allow the driver to identify the corresponding information.

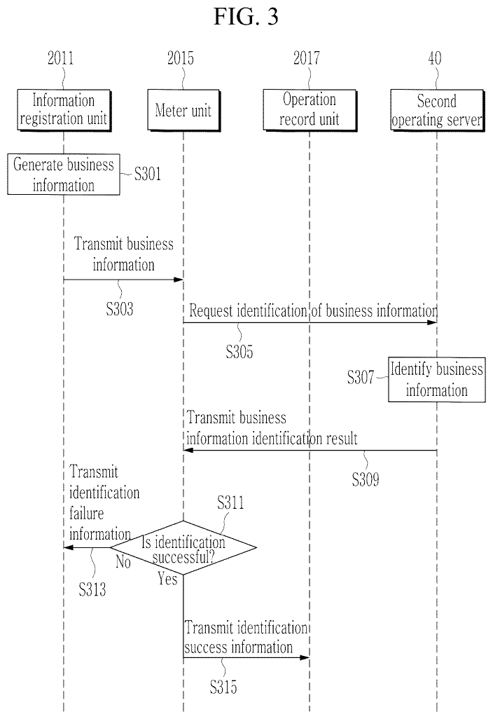

For example, when the vehicle number information query is successful, the business information identification procedure illustrated in FIG. 3 may then be performed.

FIG. 3 is a flowchart of a method for identifying business information according to an exemplary embodiment.

When the information registration unit 2011 receives the vehicle number information query success information from the operation record unit 2017, the information registration unit 2011 generates the business information (S301).

For example, the information registration unit 2011 may control the input/output unit 209 to output a screen for requesting the driver to input the business information. The driver may input the business information through the input/output unit 209. The business information may include information on a number used for identifying the business, such as a business registration number, etc. The information registration unit 2011 may generate the business information by receiving the information input from the input/output unit 209.

The information registration unit 2011 transmits the business information to the meter unit 2015 (S303).

The meter unit 2015 receives the business information and requests the second operating server 40 to identify the business information (S305).

The second operating server 40 identifies the business information (S307).

For example, the second operating server 40 may identify whether the received business registration number is a number registered in the second operating server 40. The second operating server 40 may determine that the business information identification is unsuccessful when the received business registration number does not correspond to the number registered in the second operating server 40. The second operating server 40 may determine that the business information identification is successful when the received business registration number is the number registered in the second operating server 40. The second operating server 40 may transmit an identification result including the business information identification success or failure information to the meter unit 2015.

The meter unit 2015 determines whether the identification is successful (S311).

The meter unit 2015 transmits the received identification failure information to the information registration unit 2011 when the business information identification is unsuccessful (S313).

For example, the identification failure information may include a message indicating that the business registration number is not the number registered in the second operating server 40, an error code, or a message for guiding re-identification of the business registration number. Further, the input/output unit 209 outputs the identification failure information to allow the driver to identify the corresponding information.

The meter unit 2015 transmits the received identification success information to the operation record unit 2017 when the business information identification is successful (S315).

For example, the identification success information may include a message for informing that the business registration number is the number registered in the second operating server 40 or a message for guiding a terminal registration procedure. Further, the input/output unit 209 outputs the identification success information to allow the driver to identify the corresponding information.

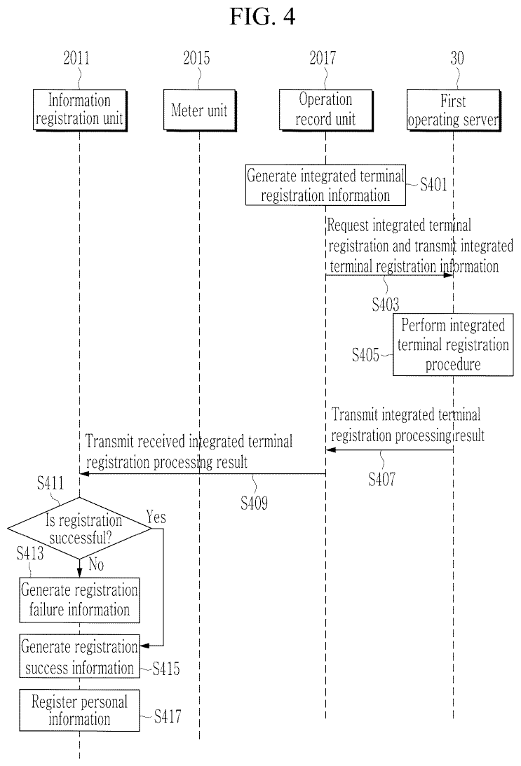

For example, when the business information identification is successful, the terminal registration procedure illustrated in FIG. 4 may then be performed.

As described above, in embodiments of the present disclosure, it is described that the business information identification procedure illustrated in FIG. 3 is performed after the vehicle number information query procedure illustrated in FIG. 2, but the present disclosure is not limited thereto. That is, the vehicle number information query procedure and the business information identification procedure may be simultaneously performed or the business information identification procedure may also be first performed.

FIG. 4 is a flowchart of a terminal registration method according to an exemplary embodiment.

When the operation record unit 2017 receives the business information identification success information from the meter unit 2015, the operation record unit 2017 generates the integrated terminal registration information (S401).

For example, the integrated terminal registration information may include the vehicle number information including the VIN and the automobile registration number, and the business information.

The operation record unit 2017 requests the registration of the integrated terminal 20 to the first operating server 30 and transmits the integrated terminal registration information (S403).

The first operating server 30 receives the integrated terminal registration information and performs an integrated terminal 20 registration procedure (S405).

The first operating server 30 transmits an integrated terminal registration processing result to the operation record unit 2017 (S407).

The operation record unit 2017 transmits the received integrated terminal registration processing result to the information registration unit 2011 (S409).

For example, the first operating server 30 may register that a vehicle corresponding to the received integrated terminal registration information is a vehicle providing the taxi service. The first operating server 30 may determine that the registration of the integrated terminal 20 is unsuccessful when there is an error in the integrated terminal registration information. The first operating server 30 may determine that the registration of the integrated terminal 20 is successful when the corresponding information is registered in the first operating server 30 because there is no error in the integrated terminal registration information. The first operating server 30 may transmit a registration processing result including integrated terminal 20 registration success or failure information to the operation record unit 2017. The operation record unit 2017 transmits the received integrated terminal registration processing result to the information registration unit 2011.

The information registration unit 2011 determines whether the registration is successful (S411).

The information registration unit 2011 generates the registration failure information when the registration of the integrated terminal 20 is unsuccessful (S413).

For example, the registration failure information may include a message indicating that the integrated terminal may not be registered as the integrated terminal registration information, the error code, or a message for guiding re-identification of the integrated terminal registration information. Further, the input/output unit 209 outputs the registration failure information of the integrated terminal 20 to allow the driver to identify the corresponding information.

The information registration unit 2011 generates the registration success information when the registration of the integrated terminal 20 is successful (S315).

For example, the registration success information may include a message for informing that a vehicle corresponding to the VIN, automobile registration number, and business registration number is registered in the first operating server 30 or a message for guiding a personal information registration procedure. Further, the input/output unit 209 outputs the registration success information to allow the driver to identify the corresponding information.

The information registration unit 2011 registers personal information (S417). Thereafter, the integrated terminal 20 and driver registration procedures are terminated.

For example, the information registration unit 2011 may output a screen for requesting the driver to input the personal information to the input/output unit 209. The driver may input the personal information through the input/output unit 209. The information registration unit 2011 may register the personal information in the information registration unit 2011 by receiving the information input from the input/output unit 209. The personal information may include a driver code including a taxi driving license number, a cellular phone number, or an employee ID number. Hereinabove, it is described that after the registration of the integrated terminal 20 is successful, the personal information is registered, but the present disclosure is not limited thereto and the personal information registration may also be performed prior to the registration of the integrated terminal 20.

Here, one or multiple personal information may be registered. For example, when the driver sets the taxi type to the individual through the input/output unit 209, the information registration unit 2011 may control the input/output unit 209 to output a screen for requesting inputting one personal information. As another example, when the driver sets the taxi type to the corporate through the input/output unit 209, the information registration unit 2011 may control the input/output unit 209 to output a screen for requesting inputting multiple personal information. Thereafter, the drivers of the corporate taxi select the registered personal information to provide the taxi service through the vehicle 10.

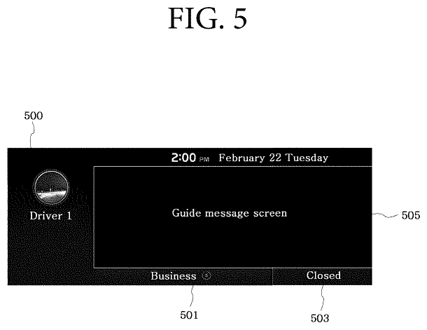

Hereinafter, the operation of the mode selection unit 2013 will be described with reference to FIGS. 5 to 7.

FIG. 5 is a view illustrating a mode selection screen according to an exemplary embodiment.

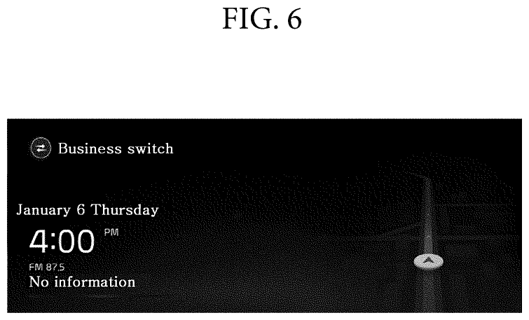

FIG. 6 is a view illustrating a closed mode screen according to an exemplary embodiment.

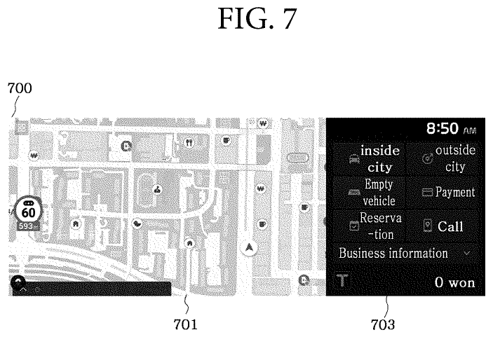

FIG. 7 is a view illustrating a business mode screen according to an exemplary embodiment.

The mode selection unit 2013 may control the input/output unit 209 to output the mode selection screen. Referring to FIG. 5, the mode selection screen 500 may include a ‘business’ mode selection button 501, a ‘closed’ mode selection button 503, and a guide message 505. The guide message 505 may include a message for guiding obeying traffic rules or a message regarding cautions at the time of manipulating the terminal.

The driver may select and input the ‘business’ or ‘closed’ mode through the input/output unit 209. The mode selection unit 2013 may control the input/output unit 209 to receive input mode information and output a screen according to the selected mode.

For example, when the driver selects and inputs the ‘closed’ mode, the mode selection unit 2013 may control the input/output unit 209 to output a general vehicle 10 interface screen illustrated in FIG. 6.

As another example, when the driver selects the ‘business’ mode, the mode selection unit 2013 may control the input/output unit 209 to output a taxi business interface screen 700 illustrated in FIG. 7. The taxi business interface screen 700 may include a map screen 701 and a business screen 703. The map screen 701 may provide a location of the current vehicle 10 and a surrounding map according to the movement of the vehicle 10. The business screen 703 may include at least one of a button capable of selecting whether the taxi is operated inside or outside a city, a button for indicating that the taxi is an empty vehicle, a button for processing an operation fee payment procedure, a button for processing a reservation procedure, a button for processing a call, or a button for identifying business information, but is not limited thereto.

As described above, the taxi service providing system directly queries and identifies the VIN, the automobile registration number, and the business registration number to the operating server to perform the terminal registration procedure, and as a result, the driver who intends to provide the taxi service can conveniently and accurately identify the availability of each information and increase the convenience of the terminal registration procedure.

As described above, when the taxi type is the corporate taxi, multiple personal information is registered and the drivers of the corporate taxi select the registered personal information thereof to provide the taxi service, and as a result, the taxi business can be efficiently performed even by using one vehicle, and the driver of the corporate taxi can conveniently provide the taxi service.

As described above, by changing the closed or business mode through the mode selection screen, either general driving or taxi service providing may be performed by one vehicle, thereby efficiently and conveniently providing the taxi service.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A system for providing a taxi service, the system comprising:
an integrated terminal configured to communicate with an operating server that provides a response to a request received from a user terminal through a network, wherein the integrated terminal is configured to:
receive a vehicle number information query result in response to a vehicle number information query request from a first operating server;
receive a business information identification result in response to a business information identification request from a second operating server; and
request the first operating server to register the integrated terminal by using the business information and the vehicle number information comprising a vehicle identification number (VIN) and an automobile registration number.

2. The system of claim 1, wherein the integrated terminal is configured to receive the VIN from a vehicle.

3. The system of claim 1, wherein:
the integrated terminal comprises an information registration unit configured to receive vehicle type information, the vehicle number information, and the business information, to receive an integrated terminal registration processing result, and to request and receive personal information for a driver of a vehicle;
the vehicle type information comprises information regarding whether the vehicle is a vehicle operated by an individual or a vehicle operated by a corporation; and
the personal information comprises a driver code including a taxi driving license number, a cellular phone number, or an employee ID number.

4. The system of claim 1, wherein the integrated terminal comprises an operation record unit configured to receive the VIN and the automobile registration number, to request the query of the vehicle number information to the first operating server, to receive an identification result of the business information, and to request the first operating server to register the integrated terminal by using the queried vehicle number information and the identified business information.

5. The system of claim 1, wherein the integrated terminal comprises a meter unit configured to request the second operating server to identify the business information by receiving the business information.

6. The system of claim 1, wherein the vehicle number information query result comprises a result of querying whether the automobile registration number is a number registered in the first operating server or a result of querying whether the VIN and the automobile registration number correspond to each other.

7. The system of claim 1, wherein the business information identification result comprises a result of identifying whether a business registration number is a number registered in the second operating server.

8. The system of claim 1, wherein the first operating server comprises a server of a public organization or an ITS (Intelligent Transport Systems)-related organization.

9. The system of claim 1, wherein the second operating server comprises an app meter business server.

10. The system of claim 1, wherein:
the integrated terminal comprises a mode selection unit configured to control another screen to be output according to a selected mode;
the selected mode comprises a business mode or a closed mode;
the mode selection unit is configured to control a taxi business interface screen including a map screen and a business screen to be output in the business mode; and
the mode selection unit is configured to control a general vehicle interface screen to be output in the closed mode.

11. A method for providing a taxi service, the method comprising:
receiving a vehicle number information query result in response to a vehicle number information query request from a first operating server;
receiving a business information identification result in response to a business information identification request from a second operating server; and
requesting the first operating server to register an integrated terminal by using the business information and the vehicle number information comprising a vehicle identification number (VIN) and an automobile registration number.

12. The method of claim 11, further comprising receiving the VIN from a vehicle.

13. The method of claim 11, further comprising:
requesting inputting of vehicle type information, the vehicle number information, and the business information; and
requesting inputting of personal information for a driver of a vehicle.

14. The method of claim 13, wherein the vehicle type information comprises information regarding whether the vehicle is a vehicle operated by an individual or a vehicle operated by a corporation.

15. The method of claim 13, wherein the personal information comprises a driver code comprising a taxi driving license number, a cellular phone number, or an employee ID number.

16. The method of claim 11, wherein receiving the vehicle number information query result in response to the vehicle number information query request from the first operating server comprises:
receiving a result of querying whether the automobile registration number is a number registered in the first operating server; or
receiving a result of querying whether the VIN and the automobile registration number correspond to each other.

17. The method of claim 11, wherein receiving the business information identification result in response to the business information identification request from the second operating server comprises receiving a result of querying whether a business registration number is a number registered in the second operating server.

18. The method of claim 11, wherein the first operating server comprises a server of a public organization or an ITS (Intelligent Transport Systems)-related organization.

19. The method of claim 11, wherein the second operating server comprises an app meter business server.

20. The method of claim 11, further comprising:
outputting another screen according to a selected mode, wherein the selected mode comprises a business mode or a closed mode;
outputting a taxi business interface screen including a map screen and a business screen when the business mode is selected; and
outputting a general vehicle interface screen when the closed mode is selected.
